(19) United States
(12) Patent Application Publication
(10) Pub. No.: US 2023/0140952 A1
(43) Pub. Date: May 11, 2023

(54) ASYMMETRIC FUNCTIONAL PANEL

(71) Applicant: PERI SE, Weissenhorn (DE)

(72) Inventors: Andreas Spiegl, Weissenhorn (DE); Guenther Staudenrausch, Weissenhorn (DE)

(73) Assignee: PERI SE, Weissenhorn (DE)

(21) Appl. No.: 18/000,283

(22) PCT Filed: May 26, 2021
(86) PCT No.: PCT/EP2021/063968

§ 371 Date: Nov. 29, 2022

(30) Foreign Application Priority Data
May 29, 2020 (DE) 10 2020 114 449.0

(51) Int. Cl. E04G 9/04; B32B 7/03; B32B 21/14; B32B 21/04; B32B 21/13; E04G 9/10

(52) U.S. Cl. CPC E04G 9/04; B32B 7/03; B32B 21/13; B32B 21/14; B32B 21/042; E04G 9/10; B32B 2250/05; B32B 2255/08; B32B 2255/26; B32B 2307/546; B32B 2307/734

(57) ABSTRACT

The invention relates to a functional panel for receiving surface loads comprising a plurality of veneer layers that are arranged one on top of another and are connected together in a materially bonded manner, wherein a part of these veneer layers has an A-fibre direction, and another part of these veneer layers has a B-fibre direction oriented at more or less 90° to the A-fibre direction. The functional panel has a central plane defined substantially in the middle of the functional panel in the in the thickness direction. The cumulative thickness of the veneer layers with the A-fibre direction differs from the cumulative thickness of the veneer layers with the B-fibre direction on a first side of the central plane, and the cumulative thickness of the veneer layers with the A-fibre direction differs from the cumulative thickness of the veneer layers with the B-fibre direction on the second side located on the opposite from the first side of the central plane. As a result, the functional panel has an asymmetric structure in its thickness direction. The invention also relates to the use of a functional panel as a formwork shell for the formwork of a building part, and a method for producing the formwork of a building part with at least one functional panel.

The invention relates to a functional panel for receiving surface loads comprising a plurality of veneer layers that are arranged one on top of another and are connected together in a materially bonded manner, wherein a part of these veneer layers has an A-fibre direction, and another part of these veneer layers has a B-fibre direction oriented at more or less 90° to the A-fibre direction. The functional panel has a central plane defined substantially in the middle of the functional panel in the thickness direction. The cumulative thickness of the veneer layers with the A-fibre direction differs from the cumulative thickness of the veneer layers with the B-fibre direction on a first side of the central plane, and the cumulative thickness of the veneer layers with the A-fibre direction differs from the cumulative thickness of the veneer layers with the B-fibre direction on the second side located opposite of the first side of the central plane. As a result, the functional panel has an asymmetric structure in its thickness direction. The invention also relates to the use of a functional panel as a formwork shell for the formwork of a building part and to a method for producing the formwork of a building part with at least one functional panel.

In various applications, functional panels are used which are, at least partly, made of natural, renewable raw materials, but synthetically formed or combined. Such functional panels have improved properties as compared to purely natural plates such as, for example, wooden boards. A typical functional panel is a plywood panel or a veneered plywood panel. In such plywood panels, a plurality of wooden layers, the so-called veneer layers, are arranged on top of each other and adhesively bonded to each other. As compared to single layer, natural wooden boards, plywood panels are considerably more dimensionally stable, particularly in case of a varying moisture content in the panels. Wooden materials tend to expand transverse to the fibre direction with an increasing moisture content, while almost no expansion takes place along the fibre direction. To prevent this direction-dependent moisture expansion and shrinkage, veneer layers are placed on top of each other and connected to each other so that the fibre directions of adjacent layers cross each other in plywood panels. In this way, the fibres of one veneer layer prevent the moisture expansion and shrinkage of the adjacent veneer layer, in which the fibre direction extends so as to be substantially offset by 90°. The mechanical properties, particularly the tensile and bending strength, are different from the mechanical properties in a direction transverse to the fibre direction in a direction parallel to the fibre direction in each veneer layer. In natural materials containing fibres, this property is always given. In multi-layer veneered plywood panels as well, the mechanical properties are different from each other in different load directions when regarded in a plan view of the functional panel. This property is undesired, particularly in functional panels intended for receiving surface loads. When applying a surface load to a known veneered plywood panel the deflection in a first load direction is larger than the deflection in a second load direction extending orthogonal to the first load direction. This larger deflection results from a lower bending strength of the functional panel in this first load direction. However, for safely receiving surface loads, it is advantageous when a functional panel has the same or at least similar mechanical properties in all directions and when therefore also the deflection resulting from the surface load is the same or at least similar in all directions. This directional dependency of the mechanical properties of a veneered plywood panel is very pronounced in panels having a small number of layers and slightly improves when a higher number of veneer layers is provided. However, also veneered plywood panels having a higher number of layers, also referred to as multiplex panels, have different mechanical properties depending on the direction.

The object of the invention is therefore to propose solutions by which surface loads can be received in a more uniform and directionally more independent way by elements based on natural materials.

This object is solved by a functional panel for receiving surface loads comprising a plurality of veneer layers that are arranged one on top of another and are connected together in a materially bonded manner, wherein a part of these veneer layers has an A-fibre direction, and another part of these veneer layers has a B-fibre direction oriented at more or less 90° to the A-fibre direction. The functional panel has a central plane defined substantially in the middle of the functional panel in the in the thickness direction. The cumulative thickness of the veneer layers with the A-fibre direction differs from the cumulative thickness of the veneer layers with the B-fibre direction on a first side of the central plane, and the cumulative thickness of the veneer layers with the A-fibre direction differs from the cumulative thickness of the veneer layers with the B-fibre direction on the second side located opposite of the first side of the central plane. Here, the ratio of the cumulative thicknesses of the veneer layers with the A-fibre direction to the cumulative thicknesses of the veneer layers with the B-fibre direction on the first side of the central plane is different from the ratio of the cumulative thicknesses of the veneer layers with the A-fibre direction to the cumulative thicknesses of the veneer layers with the B-fibre direction on the second side of the central plane so that the functional panel has an asymmetric structure in its thickness direction. Like a known veneered plywood panel, a functional panel according to the invention comprises a plurality of veneer layers that are connected to each other and arranged one on top of another. However, the fibre directions of veneer layers adjacent to each other in the thickness direction do not always differ from each other. A part of the veneer layers has a first fibre direction referred to as A-fibre direction. Another part of the veneer layers has a B-fibre direction extending substantially orthogonal to the A-fibre direction. In known veneered plywood, veneer layers adjacent to each other in the thickness direction always have fibre directions which are different from each other. In known veneered plywood, therefore, layers with the A-fibre direction and layers with the B-fibre direction alternate. In a functional panel according to the invention, there is also at least one section in which a layer with the A-fibre direction is disposed adjacent to a layer with the B-fibre direction. In addition, however, there is also at least a section in which the fibre direction of veneer layers arranged adjacent to each other is identical. Such veneer layers arranged adjacent to each other will either both have an A-fibre direction or both a B-fibre direction. In a functional panel according to the invention, a central plane conceptually dividing the functional panel into two halves in the thickness direction is defined in the middle as viewed in the thickness direction. A first half of the functional panel is disposed on a first side of the central plane, a second half of the functional panel is disposed on the second side of the central plane. When the thicknesses of all veneer layers with the A-fibre direction on the first side of the central plane are added up and the calculated overall thickness is compared to the cumulative thickness of all veneer layers with the B-fibre direction on the first side of the central plane the two overall thicknesses are different from each other. Here, these different overall thicknesses can either be obtained by a different number of veneer layers having the same thickness or by an identical number of veneer layers which, however, have different thicknesses. The cumulative thicknesses of the veneer layers with the A-fibre direction and the B-fibre direction also differ from each other on the second side of the central plane located opposite of the first side. On this second side as well, the different overall thicknesses of the layers with the A-fibre direction and the B-fibre direction may be either obtained by an identical number of veneer layers having different thicknesses or by a different number of veneer layers having the same thickness. Apart from the property that the overall thicknesses of the veneer layers with the A-fibre direction and the B-fibre direction are different from each other on each side of the central plane, at the same time, the ratio of these cumulative thicknesses to each other is different on the first side of the central plane relative to the second side of the central plane in a functional panel according to the invention. This means that the relative thickness proportion of the veneer layers with the A-fibre direction on the first side of the central plane is different from the relative thickness proportion of the veneer layers with the A-fibre direction on the second side of the central plane. Likewise, the relative thickness proportion of the veneer layers with the B-fibre direction on the first side of the central plane is different from the relative thickness proportion of the veneer layers with the B-fibre direction on the second side of the central plane. Therefore, the entire functional panel has an asymmetric structure in the thickness direction; at the same time, one half of the functional panel conceptually divided by the central plane in the thickness direction has a larger thickness proportion of veneer layers with the A-fibre direction than of veneer layers with the B-fibre direction. In contrast, the other half located opposite of this half has a larger thickness proportion of veneer layers with the B-fibre direction than of veneer layers with the A-fibre direction. This asymmetric structure in the thickness direction is contrary to the recommendations of the professional community to configure veneered plywood or functional panels symmetrically, i.e., with regularly alternating fibre directions of the adjacent veneer layers to minimise dimensional deformation. A functional panel according to the invention, however, has a distinctly improved, more uniform rigidity in different load directions as compared to the symmetrically or uniformly configured veneered plywood panels according to prior art. In general, the veneer layers located further away from the central plane have a larger influence on the stability, particularly the bending strength, than the veneer layers disposed closer to the central plane in any functional panel. In case of the application of a surface load onto a functional panel, it will bend, the central plane forming the neutral fibre experiencing no change in length. On the side of the central plane facing away from the surface load, an elongation of the veneer layers will occur upon deflection, on the side of the central plane facing the surface load, a compression of the veneer layers will occur. The further away from the central plane the veneer layers are located, the larger is the elongation or compression. In known veneered plywood panels, the outer layers have the same fibre direction, i.e., either both an A-fibre direction or both a B-fibre direction. These outer layers have the largest distance to the central plane and are therefore the veneer layers having the largest influence on the bending strength of the plywood panel. Due to the structure of known veneered plywood panels which is uniform and symmetrical in the thickness direction, this influence of the outer layers on the bending strength is not compensated by other influencing factors. The bending strength along a direction extending parallel to the fibre direction of the outer layers is significantly larger than the bending strength along a direction extending perpendicular to the fibre direction of the outer layers in known plywood panels. However, this anisotropy of the bending strength which naturally grown wooden materials always exhibit is extremely impractical in technology since known plywood panels bend more strongly in one direction than in another direction oriented perpendicular thereto when a surface load is applied. The thinner a plywood panel is, i.e., the fewer layers it has, the larger is this anisotropy of the bending strength. A functional panel according to the invention compensates this anisotropy of the bending strength by the influence of the outer layers being compensated by an unequal distribution of the fibre direction in the inner layers. In this way, a functional panel according to the invention has an almost identical bending strength in different load directions and therefore also an almost identical deflection when surface loads are applied. For example, if the outer layers have the same fibre direction in the A-fibre direction in a functional panel according to the invention, their influence is compensated by a higher thickness proportion of inner layers with the B-fibre direction. This compensation is achieved by the features relating to the distribution or to the ratios of the cumulative thicknesses of the veneer layers with the A-fibre direction and the B-fibre direction described above. A functional panel according to the invention is advantageous in that it can be used and incorporated in any rotational orientation relative to a normal direction to the outer layers. This rotational orientation about a normal to the outer layers can be freely selected since the functional panel has almost identical bending strength values in all directions of rotation. This significantly facilitates receiving or compensating surface loads. In known plywood panels, it always has to be taken into consideration that, along the fibre direction of the outer layers, a higher bending strength is given than in a direction oriented orthogonal thereto. Therefore, the rotational direction of the plywood panel about a normal to the outer layers always has to be taken into account. This can be omitted in a functional panel according to the invention in which the anisotropy of the bending strength is eliminated or at least drastically reduced. In the following, this advantage is illustrated by way of example based on two examples. A possible application of a functional panel according to the invention is its use as a shelving board on which heavy objects are to be stored. Usually, shelving boards have a distinctly larger length than width. To obtain a deflection which is as small as possible in known plywood panels as shelving boards, the fibre direction of the outer layers has to be oriented in the longitudinal direction of the shelving board in known plywood panels. If this is not observed a significantly larger deflection of the shelving board will occur. Scraps or remnants of known plywood panels in which the fibre direction of the outer layers does not extend parallel to the longer direction cannot be used as shelving boards. However, if a shelving board is produced from a functional panel according to the invention, the fibre orientation of the outer layers does not have to be observed when cutting the functional panel into a shelving board. The construction of a shelf is thus sped up and facilitated; at the same time, also remnants can be used as shelving boards. Another possible application of a functional panel is the application as a formwork shell for the formwork of a building section. Such formwork forms a negative mould of the building section into which a viscous concrete material is filled. After the concrete material has hardened, the formwork is removed again. Such formwork has planar formwork shells which have to receive the weight and pressure of the concrete material as a surface load when it is poured in and hardens. With formwork and formwork shells as well, it is usually the case that one direction has larger dimensions than a direction perpendicular thereto. In the formwork of a wall, for example, the length of the wall is generally considerably larger than the height of the wall. Therefore, when using common plywood panels as a formwork shell, the fibre direction of the outer layers has to be oriented parallel to the longer dimension of the formwork or the formwork shell to obtain a deflection which is as small as possible. As in the example of the shelving boards, this again results in that the selection of the plywood panels has to be carried out carefully and that not each formwork shell can be used for each application. This problem does no longer exist when using a functional panel according to the invention as a formwork shell. The functional panel according to the invention can be incorporated in the formwork in various rotational orientations and has the same or almost the same bending strength in these different rotational orientations. Even in case of the use of a functional panel according to the invention as a formwork shell in the construction sector, the construction of the formwork is facilitated, and the result, namely the erection of a building part, is considerably improved due to the isotropic deflection of the formwork shell or the formwork shells. Apart from the described veneer layers connected to each other by material bond, a functional panel according to the invention may also comprise other layers made of a variety of materials. For example, coatings of synthetic materials may be applied. A functional panel according to the invention is capable of receiving surface loads in a wide variety of technical fields. The use of a functional panel according to the invention is therefore not limited to the examples described above.

In one embodiment, it is contemplated that a first surface of the functional panel is configured as a pressure side provided for receiving pressure forces as a load, and the surface of the functional panel located opposite of the pressure side is configured as a tension side wherein, in particular, the tension side is not provided for receiving a load. In this embodiment, the functional panel has a defined pressure side and a tension side located opposite of this pressure side. The pressure side is provided for receiving pressure forces as a load. The functional panel is positioned with the pressure side facing the surface load for receiving a surface load. The pressure side thus constitutes the side of the functional panel oriented towards the load. In the example of the use a functional panel as a formwork shell, the pressure side of the functional panel faces the load, i.e., the concrete material. In the example a formwork shell, the pressure side thus constitutes the concrete side of the formwork shell. The term pressure side is derived from the fact that this side is compressed in case of a deflection of the functional panel, and that therefore this area of the panel is subjected to pressure. The opposite side, the tension side, is subjected to tension under a bending load. Usually, it is not intended that a load is applied to the tension side. However, the application of a load on the tension side is possible in certain applications.

Furthermore, it is contemplated that the veneer layers forming the cover layers of the functional panel have the same fibre direction. In this embodiment, the two outer layers, also referred to as cover layers, have an identical or parallel fibre direction. This is particularly favourable for minimising the distortion of the functional panel in case of humidity fluctuations. However, it is also possible that the outer layers or cover layers are formed by veneer layers having different fibre directions.

In one embodiment, it is contemplated that the cover layer of the of functional panel on the pressure side is formed by a veneer layer with the A-fibre direction, and that the ratio of the cumulative thicknesses of the veneer layers with the A-fibre direction to the cumulative thicknesses of the veneer layers with the B-fibre direction on the first side of the central plane oriented in the direction of the pressure side is larger than the ratio of the cumulative thicknesses of the veneer layers with the A-fibre direction to the cumulative thicknesses of the veneer layers with the B-fibre direction on the second side of the central plane oriented in the direction of the tension side. In this embodiment, the cover layer on the pressure side is formed by a veneer layer with the A-fibre direction. At the same time, the relative thickness proportion of veneer layers with the A-fibre direction on the half of the functional panel facing the pressure side is larger than the relative thickness proportion of veneer layers with the A-fibre direction in the half of the functional panel facing the tension side. The two halves of the functional panel are separated from each other by the central plane. In other words, the half on the pressure side of the functional panel has a larger overall thickness of veneer layers with the A-fibre direction than an overall thickness of veneer layers with the B-fibre direction. On the tension side, it is the other way round, there, the overall thickness of the veneer layers with the B-fibre direction is larger than the overall thickness of the veneer layers with the A-fibre direction.

Furthermore, it is contemplated that, on the first side of the central plane oriented in the direction of the pressure side, the cumulative thickness of the veneer layers with the A-fibre direction is larger than the cumulative thickness of the veneer layers with the B-fibre direction. In this embodiment, the half of the functional panel facing the pressure side has a larger overall thickness of veneer layers with the A-fibre direction than the overall thickness of veneer layers with the B-fibre direction. Here, the cover layer on the pressure side is formed by a veneer layer with the A-fibre direction. This larger overall thickness of veneer layers with the A-fibre direction can be achieved by the number of the veneer layers with the A-fibre direction being larger than the number of the veneer layers with the B-fibre direction on the half of the functional panel facing the pressure side. For example, two layers with the A-fibre direction and only one layer with the B-fibre direction may be provided on the half facing the pressure side, the thickness of the individual layers being identical. Alternatively, the number of the veneer layers with the A-fibre direction and the B-fibre direction may be the same while the thicknesses of the individual layers are different from each other.

Advantageously, it is contemplated that, on the second side of the central plane oriented in the direction of the tension side, the cumulative thickness of the veneer layers with the A-fibre direction is smaller than the cumulative thickness of the veneer layers with the B-fibre direction. In this embodiment, the overall thickness of the veneer layers with the A-fibre direction is smaller than the overall thickness of the veneer layers with the B-fibre direction on the half of the functional panel facing the tension side. This means that in this embodiment in which the cover layer on the pressure side is formed by a veneer layer with the A-fibre direction the thickness proportion of veneer layers with the B-fibre direction is larger than the thickness proportion of veneer layers with the A-fibre direction on the half facing the tension side. As described before, the cover layers or outer layers of the functional panel have a larger influence on the bending strength than the layers located further inward. When the cover layer on the pressure side and the cover layer on the tension side are formed by a veneer layer with the A-fibre direction these cover layers have the effect that, without compensating measures, the bending strength along the A-fibre direction is significantly larger than in a direction oriented in the angle thereto. For compensating this anisotropy, now, the proportion of the inner layers oriented orthogonal to the fibre direction of the cover layers is increased on the tension side. The larger thickness proportion of veneer layers with the B-fibre direction in the half of the functional panel facing the tension side improves the tensile strength on the tension side and thus the bending strength of the entire functional panel along a direction parallel to the B-fibre direction. On the half of the functional panel facing the tension side, the influence of the cover layer influencing the bending strength to a large degree is balanced or compensated by a higher proportion of inner layers oriented orthogonal to the cover layer.

In another embodiment, it is contemplated that the number of the veneer layers is even or odd. The functional panel may have both an even number and an uneven number of veneer layers. Preferred is an even number of veneer layers which are conceptually separated by the central plane at half of the number of layers. However, of course a functional panel may also comprise an odd number of veneer layers as also common and established in prior art.

Skilfully, it is contemplated that the thicknesses of the veneer layers are identical or that the thicknesses of the veneer layers have a tolerance range, the tolerance range amounting to maximally +/- 10% of the nominal thickness, preferably +/- 5% of the nominal thickness, particularly preferred +/- 3% of the nominal thickness. In this embodiment, all veneer layers, both the veneer layers with the A-fibre direction and the veneer layers with the B-fibre direction, have substantially the same thickness. Since the individual veneer layers are subject to tolerances in their production certain deviations of the thickness of the veneer layers will occur in reality. A maximum thickness tolerance of +/- 3% of the nominal thickness of a veneer layer has proven particularly favourable. Alternatively, the individual veneer layers may also have intentionally different thicknesses. For example, one or a plurality of inner layers with the B-fibre direction having a larger thickness than cover layers may be provided to compensate the influence of cover layers with the A-fibre direction.

In an advantageous embodiment, it is contemplated that the number of the veneer layers is at least 5, preferably at least 6. In this embodiment, the number of the veneer layers is relatively small. The asymmetric structure for improving the anisotropy of the bending strength of the functional panel is particularly effective in case of a small number of veneer layers. In case of a higher number of veneer layers, particularly in case of a number of 20 or more veneer layers, the anisotropy of the bending strength and the deflection is less pronounced even in known veneered plywood panels so that the asymmetric structure in the thickness direction according to the invention is less significant.

Furthermore, it is contemplated that the number of the veneer layers is maximally 20, preferably maximally 12, particularly preferred maximally 10. As described before, the asymmetric thickness structure of the functional panel has a particularly advantageous effect in panels having a rather small number of veneer layers. In this embodiment, the functional panel therefore comprises a maximum of 20 veneer layers. In addition, functional panels having a small number of veneer layers can be produced more easily and at lower costs.

Skilfully, it is contemplated that the veneer layers are made of a renewable material, particularly of a wood material, for example of poplar wood, birch wood, or pine wood, or bamboo. Renewable materials always exhibit a varying mechanical behaviour parallel and orthogonal to the fibre direction. Due to their anisotropy, these materials result in the undesired behaviour encountered in prior art since elements produced from these materials also exhibit a mechanically anisotropic behaviour. The functional panel is therefore, at least partly, formed of such renewable materials since an asymmetric thickness structure of a functional panel formed merely of layers exhibiting a mechanically isotropic behaviour would not be required. Of course, a functional panel may, apart from one or a plurality of veneer layers made of a renewable material, also comprise layers made from other materials. Here, these layers made of other materials may also exhibit a mechanically anisotropic behaviour or, otherwise, a mechanically isotropic behaviour. For example, a functional panel may comprise one or a plurality of plastic layers exhibiting an isotropic mechanical behaviour. Alternatively, or in addition, it is, for example, feasible to provide one or a plurality of fibre-reinforced plastic layers which again exhibit a mechanically anisotropic behaviour. In addition, for example, also layers of metal such as, for example, of sheet metal are potential components of a functional panel.

Furthermore, it is contemplated that the functional panel has a first load direction which extends parallel to the fibre direction of the cover layer on the pressure side and parallel to the surface of the functional panel forming the pressure side, and that the functional panel has a second load direction which is oriented in the right angle to the first load direction. In a functional panel, two load directions are defined, a first load direction and a second load direction extending perpendicular thereto. This definition of the load directions facilitates the description and discussion of the mechanical behaviour of the functional panel. The bending strength along such a load direction is to be understood to be the bending strength the panel counteracts a surface load extending along the load direction with. In connection with bending, often also bending about a specific bending axis is referred to. Such a bending axis extends perpendicular to the load direction and is oriented parallel to the surface of the functional panel. For the sake of convenience, a bending strength along a load direction is referred to in the following. The first load direction is parallel to the fibre direction of the cover layer on the pressure side of the functional panel and oriented parallel to its surface. The first load direction therefore corresponds to the A-fibre direction. The second load direction is oriented orthogonal to the first load direction and corresponds to the B-fibre direction.

Conveniently, it is contemplated that the bending strength and/or the bending modulus of elasticity of the functional panel along the first load direction differ from the bending strength and/or the bending modulus of elasticity of the functional panel along the second load direction by a maximum of 30%, preferably by a maximum of 20%, particularly preferred by a maximum of 10%. In the ideal case, the mechanical properties of the functional panel, particularly the bending strength and the bending modulus of elasticity, are exactly the same along the first and the second load direction. Theoretically, this can be achieved by the asymmetric thickness structure of the functional panel. In practice, the mechanical properties are subject to tolerances so that, generally, there are small differences in the mechanical rigidity between the first load direction and the second load direction. However, these differences are considerably smaller than in known veneered plywood panels.

In one embodiment, it is contemplated that, onto at least one cover layer formed by a veneer layer, a coating is applied, the coating being made of a material different from the veneer layers. In this embodiment, the functional panel is coated on at least one of its surfaces. On at least one cover layer formed by a veneer layer a further layer is applied. Here, the coating may be applied over the entire surface or only partly on one or both cover layers. The coating consists of an active component different from the veneer layer. In particular, the coating is made of a synthetically produced material, for example a plastic material.

In an advantageous embodiment, it is contemplated that a coating made of a thermoplastic, particularly of polypropylene, is applied to the pressure side. In this embodiment, a coating of a thermoplastic is applied to the pressure side of the functional panel, i.e., to the side on which a surface load is applied. This coating on the pressure side has a thickness which is, dimensionally, in the range of the thickness of the veneer layers. A suitable material for a such a coating on the pressure side is polypropylene.

In another embodiment, it is contemplated that a coating made of a thermosetting plastic, particularly of a phenolic material, is applied to the tension side. In this embodiment, a coating of a thermosetting plastic is applied to the tension side, i.e., to the side of the functional panel facing away from the surface load. A suitable material for a such a coating on the tension side is phenol or a phenolic material. Such a coating has a moisture-repellent effect and protects the cover layer on the tension side from mechanical wear. In addition, such a coating having isotropic mechanical properties on the tension side can increase the overall bending strength and/or the overall bending modulus of elasticity of the functional panel.

Of course, also other materials can serve as a coating both on the tension side and on the pressure side as well as on both surfaces of the functional panel. Suitable coating materials are, for example, melamine, polyethylene, or an MDO (middle density overlay) film.

Skilfully, it is contemplated that coatings the thicknesses of which are configured so as to be the same or different are applied to both cover layers formed by veneer layers. In this embodiment, the functional panel is coated with a material different from the veneer layers on both sides. A functional panel coated on both sides is particularly protected and resistant to environmental influences. In this way, the service life of the functional panel is increased.

Advantageously, it is contemplated that the coating applied to the pressure side significantly influences the bending strength and/or the bending modulus of elasticity of the functional panel. In this embodiment, the coating on the pressure side of the functional panel has a significant influence on the mechanical properties of the entire functional panel. Therefore, the coating has an effect on the bending strength and/or the bending modulus of elasticity of the entire functional panel. In particular, the bending strength and/or the bending modulus of elasticity of the coating is added to the bending strength and/or to the bending modulus of elasticity of the veneer layers connected to each other. Very thin coatings such as, for example, a thin coating of a phenolic material on the tension side, have such a low bending strength and/or such a so low bending modulus of elasticity themselves that such a thin coating does not have a significant effect on the mechanical properties of the functional panel as a whole. Such a thin coating is therefore not intended for influencing the mechanical properties of the functional panel. A thicker coating as often realised by a coating of a thermoplastic on the pressure side, on the other hand, also serves to change, particularly to improve the mechanical properties of the functional panel.

Furthermore, it is contemplated that the bending strength and/or the bending modulus of elasticity of the coating along the first load direction and along the second load direction are substantially identical. In this embodiment, the material of which the coating is composed has a mechanically isotropic behaviour. The mechanical properties, particularly the bending strength and/or the bending modulus of elasticity of the coating alone are therefore the same along various load directions. Therefore, the mechanical properties of the coating do not have to be compensated by an asymmetric structure within the veneer layers in this embodiment. This is particularly advantageous since a type or kind of functional panel without a coating can be subsequently provided with various coatings or coating thicknesses. The veneer layers of the functional panel are configured so that, by an asymmetric structure in the thickness direction, the veneer layers alone have balanced or isotropic mechanical properties. This property will be maintained when a coating also having isotropic mechanical properties is applied. A functional panel according to this embodiment can therefore be adapted to various requirements or areas of application in a particular simple and cost-effective way by selecting the appropriate coating.

In one embodiment, it is contemplated that the bending strength and/or the bending modulus of elasticity of the coating are smaller than the bending strength and/or the bending modulus of elasticity of a veneer layer along the fibre direction, and that the bending strength and/or the bending modulus of elasticity of the coating are larger than the bending strength and/or the bending modulus of elasticity of a veneer layer transverse to the fibre direction. In this embodiment, the mechanical rigidity of a coating, i.e., particularly the bending strength and/or the bending modulus of elasticity of a coating on the pressure side of the functional panel ranges between the mechanical rigidity of a veneer layer along the fibre direction and the mechanical rigidity of a veneer layer transverse to the fibre direction. With such a coating, a functional panel is produced which very homogenously transmits and thus compensates tensions occurring in its interior due to a load. This homogenous transfer functions particularly well since there are no large differences in the mechanical properties of adjacent plies or layers.

In another embodiment, it is contemplated that the bending strength and/or the bending modulus of elasticity of the coating on the tension side is smaller than the bending strength and/or the bending modulus of elasticity of a veneer layer along the fibre direction, and that the bending strength and/or the bending modulus of elasticity of the coating is larger than the bending strength and/or the bending modulus of elasticity of a veneer layer transverse to the fibre direction. In this embodiment, the mechanical rigidity of a coating, i.e., particularly the bending strength and/or the bending modulus of elasticity of a coating on the tension side of the functional panel ranges between the mechanical rigidity of a veneer layer along the fibre direction and the mechanical rigidity of a veneer layer transverse to the fibre direction. As illustrated in the embodiment described above, a selection of a coating material the mechanical properties of which are within the range of the mechanical properties of the veneer layers has the effect of a homogenous overall behaviour the functional panel. In specific applications, however, it is of course also feasible to select coatings the mechanical properties of which considerably differ from the mechanical properties of the veneer layers. This is, for example, possible when the coating is extremely thin and has no significant influence on the mechanical properties of the entire functional panel due to this small thickness.

Furthermore, it is contemplated that the thicknesses of the coatings are part of the thickness of the functional panel and therefore also included in the definition of the position of the central plane. In this embodiment, it is taken into consideration that the thicknesses of the coatings on the pressure and/or on the tension side increase the overall thickness the functional panel. This consideration is to be observed when the coatings have a thickness which, in its dimensions, is close to the thicknesses of the veneer layers. The thicknesses of the coatings do not have to be taken into consideration when they are extremely thin, i.e., for example, in the µm range. As defined above, the central plane is an imaginary plane of separation between the two halves of the functional panel in the thickness direction. When a bending load is applied to the functional panel the neutral fibre is in the central plane. The one half between the central plane and the pressure side is subjected to pressure when bended, the opposite half between the central plane and the tension side is subjected to tension. By applying a coating, for example on the pressure side, the central plane is shifted in the direction of the pressure side as compared to a functional panel without a coating. When subjected to bending, therefore, partly other veneer layers are subjected to pressure or subjected to tension than this would be the case without the application of the coating. Since the veneer layers have different properties when subjected to pressure as compared to being subjected to tension the described shift of the central plane has to be taken into consideration in the design of the asymmetric construction of the veneer layers. The veneer layers have to be combined so that, in case of a displaced central plane, the desired isotropic mechanical properties of the entire functional panel are restored by the sum of the properties of the veneer layers arranged one on top of another. Here, only the thickness of the coating is relevant in the design of the veneer layers. Conveniently, since the coating has isotropic mechanical properties, no anisotropic behaviour of the coating needs to be compensated by the asymmetric arrangement of the veneer layers. Even in case of a displaced central plane, only the mechanical anisotropy inherent to the individual veneer layers is compensated by the asymmetric thickness structure within the veneer layers.

The object of the invention is also solved by the use a functional panel according to one of the embodiments described above as a formwork shell for the formwork of a building part. A functional panel having the asymmetric thickness structure of veneer layers described above is particularly suitable as a formwork shell in the erection of buildings. Generally, naturally renewable materials such as particularly wood are well suited materials for a formwork shell since they have excellent mechanical properties at a low weight. However, when using renewable materials as a formwork shell, there is also the problem of the anisotropic mechanical behaviour described above. The use of a functional panel as a formwork shell the mechanical properties of which are substantially isotropic considerably facilitates the formwork of a building part to be erected. A functional panel can be used as a formwork shell in the formwork in any rotational direction and always exhibits an identical or very similar mechanical behaviour there, particularly with regard to the bending strength and/or the bending modulus of elasticity. During the erection of a building part, a surface load is applied to a formwork shell by the weight and pressure of the filled-in concrete material. It is the function of the formwork shell to compensate this surface load and to remain as dimensionally stable as possible in the process. Non-uniform deflections of a formwork shell are visible on the hardened concrete material after the erection of the building part and should therefore be avoided. By using a functional panel as a formwork shell, it is achieved that the formwork deforms uniformly and that therefore a dimensionally stable, optically attractive building part emerges. Of course, the use of a functional panel is not limited to a use as a formwork shell. Conveniently, a functional panel can also be used as a shelving board, a floor for transport means or transport vehicles, a structural or frame element, a furniture element, a support element in tunnel construction or mining or for similar applications.

In a preferred embodiment of the use, it is contemplated that the pressure side of the functional panel used as a formwork shell faces the material, particularly the concrete material, of the building part to be erected. The pressure side of the functional panel is provided for receiving surface loads. The functional panel is designed so that, when a surface load is applied to the pressure side, the desired isotropic mechanical properties are available. Therefore, the pressure side conveniently faces the surface load produced by the concrete material when a functional panel is used as a formwork shell.

Furthermore, it is contemplated that the functional panel used as a formwork shell is fastened to a formwork support on its tension side. In this embodiment of the use, the formwork shell is fastened to a formwork support on its tension side. Here, for example, the formwork support may be formed by a metal frame or a frame of wooden elements. With such a fixation, it is ensured that the pressure side of the functional panel faces the concrete material and thus the surface load during the erection of a building part.

Moreover, the object of the invention is solved by a method for producing a functional panel according to one of the embodiments described above comprising the steps: A) connecting the veneer layers in a materially bonded manner and B) applying the coatings to the cover layers of the connected veneer layers. A method according to the invention serves the production of a functional panel according to the invention having an asymmetric thickness structure. In a first process step, a plurality of veneer layers formed of a naturally renewable material are arranged on top of each other and connected to each other in a materially bonded manner. The arrangement of the veneer layers is carried out so that the asymmetric thickness structure described above in connection with the functional panel is obtained. Here, the veneer layers are arranged so that the large influence of the fibre direction of the cover layers is compensated by increasing the proportion of inner layers with a fibre direction extending perpendicular to the fibre direction the cover layers. With regard to the arrangement and the properties of the cover layers arranged one on top of another and connected to each other reference is made to the description of the functional panel. Generally, the veneer layers are connected to each other in a materially bonded manner, particularly adhesively bonded to each other. Here, this material connection can be established at an elevated temperature and at an increased pressure. Conveniently, the veneer layers are heated and connected to each other under pressure in a press. After the material connection of the veneer layers, a veneered plywood panel having substantially isotropic mechanical properties was produced. If required, a coating can then be applied to one or also to both sides of this panel. Here, the selection of the coating depends on the intended application of the functional panel. When the functional panel is coated on two sides, conveniently, first a first coating is applied to the one side, for example to the pressure side, and then the coating is applied the opposite side, for example the tension side. In the process, different coating methods can be used.

Finally, the object of the invention is solved by a method for producing the formwork of a building part in which at least one functional panel according to one of the embodiments described above is used as a formwork shell comprising the steps of:

I) setting up and positioning a formwork support, and II) attaching at least one formwork shell formed by a functional panel, the pressure side being oriented towards the building part to be erected, and the tension side being oriented towards formwork support. In step II), the orientation of the formwork shell is variable about a position axis oriented in a normal direction to the pressure side since the mechanical properties of the functional panel, particularly its bending strength and/or its bending modulus of elasticity are identical in all load directions orthogonal to the position axis or deviate from each other by a maximum of 30%, preferably by a maximum of 20%, particularly preferred by a maximum of 10%. This method according to the invention serves the production of the formwork of a building part to be erected. The formwork is provided for being filled with a viscous material, particularly with a concrete material. In a first step I), a formwork support corresponding to the geometry of the planned building part is set up. Here, the formwork support is assembled from a plurality of support elements. These support elements are formed by metal frames to which, in the next step, the formwork shell can be attached. After the assembly of the formwork support, the formwork shell at least partly formed by a functional panel according to one of the embodiments described above is attached in a second step II). For example, the formwork shell is screwed to the formwork support or fastened with nails. The pressure side of the functional panel forming at least part of the formwork shell is oriented towards the building part to be erected, and the tension side is oriented towards formwork support here. A particular advantage of the method according to the invention is that the rotational orientations of the functional panel relative to the formwork support does not play a role in the method. This means that a functional panel can be attached to the formwork support in any rotational orientation thereto since it always exhibits the same, substantially isotropic mechanical behaviour in all rotational orientations. Here, rotational orientations refer to the orientation of the functional panel about a position axis. This position axis is an imaginary axis disposed parallel to a direction extending perpendicular to the pressure side, the normal direction. In other words, a functional panel applied to the formwork support with the tension side can be arbitrarily rotated in this applied state. These rotational orientations are therefore variable so that a formwork shell formed by a functional panel can be used in different positions and in different orientations relative to the formwork. In general, a formwork is assembled from a plurality of formwork elements or formwork shells. In this case, the formwork often has a complex geometry which has to be assembled from formwork shells having various shapes. A functional panel is particularly advantageous for the formwork since it can be integrated into the formwork in any position in any orientation. In this way, when erecting the formwork of a building part, fewer elements are required for the formwork as compared to the use of formwork shells which can only be integrated into the formwork in one rotational orientation. Each formwork shell formed by a functional panel can be integrated into the formwork in a considerably more flexible way than known veneered plywood panels. In the process, always an almost uniform mechanical behaviour is given in different load directions. Another advantage of the method according to the invention is that gaps in a formwork can be closed by arbitrary scraps of functional panels. When, in the formwork, there is still a gap having a complex geometry this gap can be closed by cutting precisely the required geometry from a scrap of a functional panel and inserting it. Here, it does not have to be observed that the inserted scrap is rotated and inserted in precisely one orientation either. Therefore, the material requirements and thus also the costs of the formwork of a building part are reduced by a method according to the invention.

The features, effects, and advantages disclosed in connection with the functional panel also apply in connection with the use and the method as disclosed. The same applies vice versa; the features, effects and advantages disclosed in connection with the use and the method also apply in connection with the functional panel as disclosed.

In the Figures, embodiments of the invention are schematically illustrated. Here,

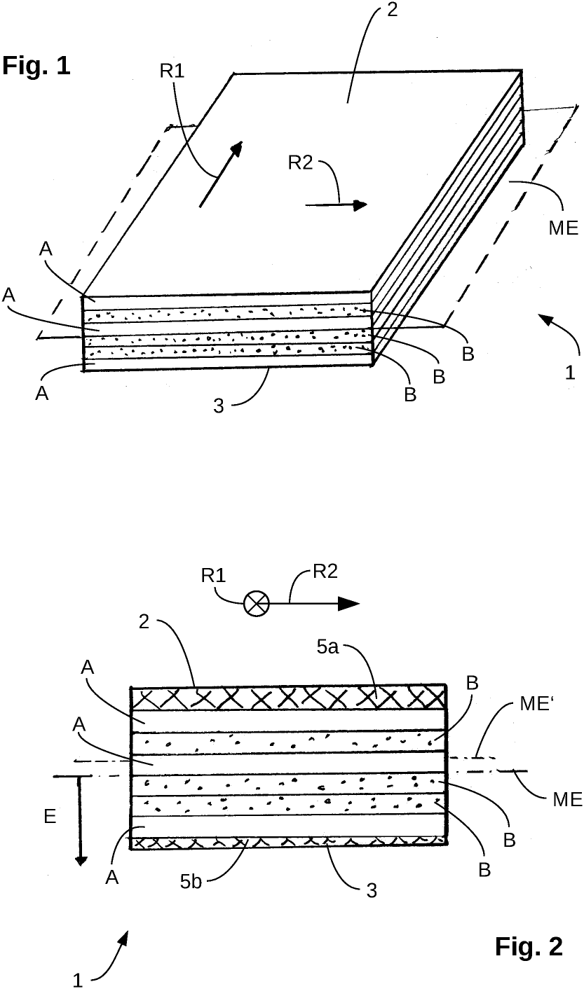

FIG. 1 shows a schematic perspective view of an embodiment of a functional panel according to the invention,

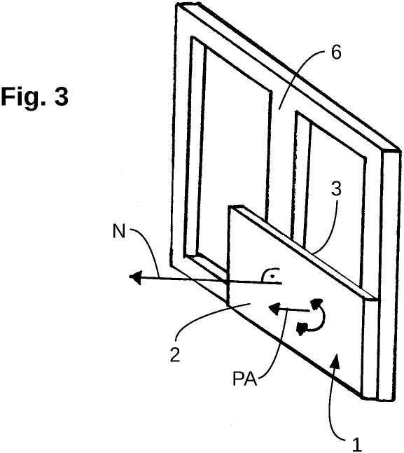

FIG. 2 shows a schematic cross sectional view of an embodiment of a functional panel according to the invention,

FIG. 3 shows a schematic perspective view of a formwork including an embodiment of a functional panel according to the invention in the process of being assembled.

In the Figures, identical elements are designated by the same reference numerals. In principle, the described properties of an element described with reference to a Figure also apply to the other Figures. Indications of directions such as above or below relate to the described Figure and are to be contextually applied to the other Figures.

FIG. 1 shows a schematic perspective view of an embodiment of a functional panel 1 according to the invention. In FIG. 1, a section of a multi-layer functional panel 1 can be seen. The dimensions in the length and width of the functional panel 1 may, of course, vary, so that the illustrated section only serves the exemplary description of the functional panel 1. The illustrated functional panel 1 consists of a total of six veneer layers A, B made of a naturally renewable material. In the illustrated embodiment, the veneer layers A, B are made of veneer wood. The veneer wood may be made of hard wood or soft wood. Suitable veneer wood types are, for example, poplar, birch, or beech. The veneer layers A, B are arranged on top of each other and firmly connected to each other in a materially bonded manner. The fibre directions of the veneer layers A, B are partly different from each other. The cover layer disposed on top is formed by a veneer layer A the fibres of which extend along an A-fibre direction extending from the right to the left in FIG. 1. The veneer layer B disposed directly below the cover layer has a B-fibre direction oriented at 90° to the A-fibre direction which extends from the front to the back in FIG. 1. For a better understanding, the illustrated cut fibres are represented by dots in the veneer layers B with the B-fibre direction on the side of the functional panel 1 facing forwards in FIG. 1. Based on these dots, it can be discerned whether a veneer layer A, B is a veneer layer A with the A-fibre direction or a veneer layer B with the B-fibre direction. The central plane ME conceptually divides the functional panel 1 into in an upper and a lower half. The central plane ME extends parallel to the surfaces of the veneer layers A, B. The illustrated embodiment of a functional panel comprises a total of six veneer layers A, B all having the same thickness. The central plane ME is located in the middle of the functional panel 1 between the three upper veneer layers A, B and the three lower veneer layers A, B. The surface or side facing upwards in FIG. 1 is the pressure side 2 provided for applying a surface load. The surface of the functional panel 1 located opposite of the pressure side 2 is the tension side 3. In the illustrated embodiment, the cover layers on the pressure side 2 and on the tension side 3 are formed by veneer layers A with the A-fibre direction. The two cover layers thus have the same fibre direction here. However, it is also feasible that the cover layers on the tension side 3 and the pressure side 2 have different fibre directions. The functional panel 1 has an asymmetric structure in the thickness direction. The thickness direction of the functional panel 1 extends from the top to the bottom in FIG. 1, from the tension side 2 to the pressure side 3 or vice versa. The sequence of the veneer layers A, B in the thickness direction is irregular: starting from the top, the cover layer on the tension side 2 is formed by a veneer layer A with the A-fibre direction. Adjacent to and below it, a veneer layer B with the B-fibre direction is disposed, which in turn is followed by a veneer layer A with the A-fibre direction. On the first half of the functional panel 1 extending from the central plane ME to the pressure side 2, thus, two veneer layers A and only one veneer layer B having the same thickness are disposed. In this first half, therefore, the cumulative thickness of the veneer layers A is larger than the cumulative thickness of the veneer layers B. In addition, the thickness proportion of the veneer layers A is larger in the ratio to the thickness proportion of the veneer layers B. The ratio of the cumulative thicknesses of the veneer layers A to the veneer layers B is 2 to 1 in the first half. On the second half extending from the central plane ME to the tension side 3, adjacent to the central plane ME, two veneer layers B are disposed adjacent to each other. The lower end of the second half is formed by the cover layer formed by a veneer layer A. The cumulative thickness of the veneer layers A is therefore smaller than the cumulative thickness of the veneer layers B on the second side of the central plane ME. The cumulative thicknesses on the second side are therefore exactly the reverse of the cumulative thicknesses on the first side. On the second side, the thickness proportion of the veneer layers A is, in contrast to the first half, smaller than the thickness proportion of the veneer layers B. The ratio of the cumulative thicknesses of the veneer layers A to the veneer layers B is 1 to 2 in the second half. In the second half of the functional panel 1 facing the tension side 3, the thickness proportion of the veneer layers B is therefore larger than the thickness proportion of the veneer layers B in the first half facing the pressure side 2. When a surface load is applied to the pressure side 2 the veneer layers A, B disposed below the central plane ME are subjected to tension. The load or the elongation is the smallest directly adjacent to the central plane and the largest on the surface of the tension side 3. Here, the cover layer on the tension side 3 bears the highest load and, in the reverse conclusion, provides the largest and most effective share in the resistance against the bending load. The cover layer has an A-fibre direction. In a wood material, the mechanical rigidity is considerably larger parallel to the fibre direction than transverse to the fibre direction. The cover layer on the tension side 3 therefore has a high tensile strength in a direction extending from the right to the left in FIG. 1, parallel to the A-fibre direction. On the pressure side 2 of the functional panel, two load directions R1 and R2 represented by two arrows are illustrated. The load direction R2 extends parallel to the A-fibre direction. When a line load parallel to the load direction R2 is applied, in other words, when a bending load is applied along the load direction R2 the cover layer facing downwards which has an A-fibre direction has a high bending strength and a high bending modulus of elasticity. When a bending load along the other load direction R1 located orthogonal to the load direction R2 is applied the bending strength and the bending modulus of elasticity of the cover layer facing downwards are considerably smaller. Without other veneer layers, the cover layer on the tension side 3 would therefore exhibit an anisotropic mechanical behaviour, with strengths against a bending load in the load direction R2 and weaknesses against a bending load in the load direction R1. To compensate this anisotropy, the thickness proportion of the veneer layers B is selected so that it is larger in the second half of the functional panel 1 facing downwards. These veneer layers B are located further inwards, i.e., closer to the neutral fibre extending in the central plane ME so that the influence of these veneer layers B against a bending load decreases with increasing proximity to the central plane. This influence of the distance from the neutral fibre is compensated by the thickness proportion of the veneer layers B being significantly higher than the proportion of the veneer layers A. In this way, the bending strength and the bending modulus of elasticity of the entire functional panel 1 against a bending load in the load direction R1 are improved and increased. As a result of this asymmetric thickness structure, the functional panel 1 has an almost identical bending strength and identical bending modulus of elasticity in the two load directions R1 and R2. Despite its structure of naturally renewable wooden materials, the illustrated functional panel 1 exhibits an almost isotropic mechanical behaviour when exposed to a surface load applied to the pressure side 2. When a surface load is applied to the pressure side 2 the functional panel 1 therefore bends to a comparable extent parallel to the load direction R1 as compared to a direction parallel to the load direction R2. In the ideal case, the bending strength and the bending modulus of elasticity are identical along the load directions R1 and R2. However, in reality these mechanical characteristics slightly deviate from each other. Here, such a slight deviation means, for example, a deviation of maximally 20 %, preferably of maximally 10 %, particularly preferred of maximally 5 % from each other.

FIG. 2 shows a schematic cross sectional view of an embodiment of a functional panel 1 according to the invention. In contrast to the embodiment of a functional panel 1 illustrated in FIG. 1, the embodiment of a functional panel 1 in FIG. 2 has a coating 5a, 5b on both sides. The functional panel 1 in FIG. 2 also comprises six veneer layers A, B of veneer wood the arrangement of which on top of each other is identical to the embodiment in FIG. 1. On the pressure side 2 of the functional panel 1 facing upwards in FIG. 2, a coating 5a is applied to the veneer layer A forming the cover layer. Here, the thickness of the coating 5a is about as large as the thickness of the veneer layers A, B. Here, the coating 5b applied to the tension side 3 is substantially thinner than the thickness of the veneer layers A, B. The coatings 5a and 5b are made of different materials. The thicker coating 5a on the pressure side 2 is made of polypropylene here, the thinner coating on the tension side 3 is made of phenol here. The thicker coating 5a made of polypropylene on the pressure side has isotropic mechanical properties when exposed to bending loads in different load directions, particularly in the two load directions R1 and R2 extending orthogonal to each other. In the illustration in FIG. 2, the load direction R2 extends from the left to the right, the load direction R1 extends into the drawing plane. By subsequently applying the coating 5a to the veneer layers A, B, therefore, no anisotropic mechanical behaviour of the entire functional panel 1 will occur. However, due to its larger thickness, the coating 5a significantly contributes to the overall bending strength and to the overall modulus of elasticity of the functional panel 1. The directionally independent rigidity of the coating 5a adds up to the rigidity obtained by the interaction of the six veneer layers A, B. By applying the coating 5a to the pressure side 2, the bending strength and the bending modulus of elasticity of the functional panel are uniformly increased here. The coating 5b applied to the tension side 3 and made of phenol is so thin that its rigidity has no significant influence on the mechanical properties the entire functional panel 1. Like the coating 5a, the coating 5b exhibits a directionally independent, isotropic mechanical behaviour. The coating 5b applied to the tension side is not provided to increase the bending strength and the bending modulus of elasticity, but only serves to protect the veneer layers A, B from environmental influences. In FIG. 2 as well, the central plane ME conceptually dividing the functional panel 1 in two halves in the thickness direction is illustrated. Here, the central plane ME is indicated so as if the two coatings 5a and 5b did not exist. The central plane ME is indicated exactly between the three upper veneer layers A, B and the three lower veneer layers A, B, the thickness of all veneer layers A, B being identical here. On the left of the functional panel 1, the distance E from the central plane is represented by an arrow starting from the central plane ME. The larger this distance E from the central plane in direction of the tension side 3 is, the larger is the influence of the layer disposed there on the bending strength and the bending modulus of elasticity of the entire functional panel 1. In FIG. 2, it can be clearly seen that the cover layer on the tension side 3 formed by a veneer layer A has the largest distance E from the central plane ME and therefore the largest influence on the mechanical rigidity of the functional panel 1. The two veneer layers B located between the central plane ME and the veneer layer A forming the cover layer have a smaller distance E to the central plane and therefore have a smaller influence on the mechanical rigidity of the functional panel 1. Due to this smaller influence of these inner layers, the overall thickness of the veneer layers B on the side of the central plane facing downwards is twice as large as the overall thickness of the veneer layer A. By increasing the thickness proportion of the veneer layers B for compensating the smaller distance E to the central plane ME, directionally independent, isotropic mechanical properties of the entire functional panel 1 are obtained. In FIG. 2, a second central plane ME‘ located above the central plane ME is indicated. In this second central plane ME‘, the thicknesses of the coatings 5a and 5b are taken into account. Since the thickness of the coating 5a is larger than the thickness of the coating 5b the dimensional centre of the entire functional panel 1 in the thickness direction in which the central plane ME‘ is defined is located further upwards than in the case in which no coating 5a, 5b is applied. It can be clearly seen in FIG. 2 that the central plane ME‘ in which, in case of a bending load on the coated functional panel 1, the neutral fibre extends is located further up than in a non-coated functional panel 1. With the thicker coating 5a on the pressure side 2, therefore, the neutral fibre moves upwards in case of a bending load so that a part of the veneer layer A through which the central plane ME‘ extends is subjected to tension. Without the coating 5a, 5b, this veneer layer would be located above the central plane ME and would, in the event of a deflection, be exclusively subjected to pressure. When coatings 5a and 5b having different thicknesses are applied to the two sides of the veneer layers A, B, therefore, the neutral fibre moves upwards in case of a bending load which in turn has to be taken into consideration in the design of the asymmetric thickness structure of the entirety of the veneer layers A, B.

FIG. 3 shows a schematic perspective view of a formwork including an embodiment of a functional panel 1 according to the invention in the process of being assembled. In FIG. 3, the use of a functional panel 1 as a formwork shell of a formwork for the erection of a building part is schematically illustrated. A functional panel 1 is well suited as a formwork shell since it exhibits a mechanically isotropic behaviour when loaded with a surface load. A formwork is erected to be capable of producing a building part, for example a wall or a ceiling, by casting. The formwork has the function to accommodate the initially liquid material, particularly a concrete material, in a shaping manner. After the material has hardened, the formwork will be removed again, and the building part remains as a negative mould of the interior of the formwork. For erecting a formwork, first a formwork support 6 is assembled and positioned in accordance with the specifications of the building part. In FIG. 3, only a small section of the formwork is illustrated which has a rectangular formwork support 6 having the shape of a frame here. For erecting the building part, further formwork supports 6 are assembled which, however, are not illustrated for the sake of clarity. The formwork support 6 is composed of metal pipes having a rectangular cross section here. In the illustrated case, a formwork for a building wall is assembled. The formwork support 6 is therefore oriented so as to extend vertically. After the assembly of the formwork support 6, the formwork shell is fastened on the formwork support 6. A part of this formwork shell is formed by a functional panel 1 here. Starting from the illustrated state, further functional panels 1 can be attached to the formwork support 6 as further parts of the formwork shell. The functional panel 1 is fastened to the formwork support 6 on its tension side 3. The pressure side 2 of the functional panel 1 faces away from the formwork support 6 and is oriented towards the section into which, later, the liquid concrete material is filled. After the concrete material was poured in, it abuts on the pressure side 2 of the functional panel 1 and will then generate a surface load acting on the functional panel 1. Orthogonally pointing away from the surface of the pressure side 2, the normal direction N to the pressure side 2 is indicated. Parallel to this normal direction N, a position axis PA extends. Such a position axis PA can be located in any position on the pressure side 2. The position axis PA is an imaginary, geometrical assist feature serving to describe the orientation of the functional panel 1 relative to the formwork support 6. When known plywood panels are used as a formwork shell, the rotational orientation of these plywood panels about a position axis PA has to be precisely observed. Since known plywood panels have different bending strengths in different load directions it always has to be ensured that, for example, such panels are positioned so that the mechanically more resilient load direction extends along the longer dimension of the panel. A known plywood panel could, in the application illustrated in FIG. 3, only be used as a formwork shell instead of the functional panel 1 if its higher load direction extended along the longest dimension of the panel extending from front right to back left. A known plywood panel in which the highest load direction extends parallel to the shorter side of the panel could not reasonably be used for this application. A functional panel 1 according to the invention is advantageous in that it can be attached to the formwork support 6 in any rotational orientation relative to the position axis PA and in that it always has the same or at least very similar mechanical properties such as the bending strength and the bending modulus of elasticity in any of these rotational orientations. These different rotational orientations are represented by the curved double arrow on the base of the depicted position axis PA. The functional panel 1 illustrated in FIG. 3 could therefore also be attached to the formwork support 6 upright, i.e., with its longest dimension extending in the vertical direction. The mechanical behaviour of the functional panel 1 exposed to a surface load generated by the cast concrete material would not change thereby. A functional panel 1 according to the invention can therefore be used as a formwork shell in a much more variable way than known plywood panels. Starting from the state illustrated in FIG. 3, other functional panels in any rotational orientation could be fastened to the formwork support 6 adjacent to the functional panel 1 already attached until the entire face of the formwork support 6 is provided with a formwork shell.

1. A functional panel (1) for receiving surface loads comprising:
a plurality of veneer layers (A, B) connected together in a materially bonded manner that are arranged one on top of another,
wherein a part of these veneer layers (A) has an A-fibre direction and another part of these veneer layers (B) has a B-fibre direction oriented at more or less 90° to the A-fibre direction,
and the functional panel (1) has a central plane (ME) defined substantially in the middle of the functional panel (1) in the in the thickness direction,
wherein the cumulative thickness of the veneer layers (A) with the A-fibre direction differs from the cumulative thickness of the veneer layers (B) with the B-fibre direction on a first side of the central plane (ME) and the cumulative thickness of the veneer layers (A) with the A-fibre direction differs from the cumulative thickness of the veneer layers (B) with the B-fibre direction on the second side located opposite of the first side of the central plane (ME);
and wherein the ratio of the cumulative thicknesses of the veneer layers (A) with the A-fibre direction to the cumulative thicknesses of the veneer layers (B) with the B-fibre direction on the first side of the central plane (ME) differs from the ratio of the cumulative thicknesses of the veneer layers (A) with the A-fibre direction to the cumulative thicknesses of the veneer layers (B) with the B-fibre direction on the second side of the central plane (ME) so that the functional panel (1) has an asymmetric structure in its thickness direction, wherein
a first surface of the functional panel (1) is configured as a pressure side (2) provided for receiving pressure forces as a load, and the surface of the functional panel (1) located opposite of the pressure side (2) is configured as a tension side (3) wherein, in particular, the tension side (3) is not provided for receiving a load, and
the cover layer the of functional panel (1) on the pressure side (2) is formed by a veneer layer (A) with the A-fibre direction, and the ratio of the cumulative thicknesses of the veneer layers (A) with the A-fibre direction to the cumulative thicknesses of the veneer layers (B) with the B-fibre direction on the first side of the central plane (ME) oriented in the direction of the pressure side (2) is larger than the ratio of the cumulative thicknesses of the veneer layers (A) with the A-fibre direction to the cumulative thicknesses of the veneer layers (B) with the B-fibre direction on the second side of the central plane (ME) oriented in the direction of the tension side (3), wherein,
on the first side of the central plane (ME) oriented in the direction of the pressure side (2), the cumulative thickness of the veneer layers (A) with the A-fibre direction is larger than the cumulative thickness of the veneer layers (B) with the B-fibre direction.

2. The functional panel (1) according to claim 1, characterised in that, on the second side of the central plane (ME) oriented in the direction of the tension side (3), the cumulative thickness of the veneer layers (A) with the A-fibre direction is smaller than the cumulative thickness of the veneer layers (B) with the B-fibre direction.

3. The functional panel (1) according to one of the preceding claims, characterised in that the number of the veneer layers (A, B) is at least 5, preferably at least 6, and/or in that the number of the veneer layers (A, B) is maximally 20, preferably maximally 12, particularly preferred maximally 10.

4. The functional panel (1) according to one of the preceding claims, characterised in that the thicknesses of the veneer layers (A, B) are identical, or in that the thicknesses of the veneer layers (A, B) have a tolerance range, wherein the tolerance range is maximally +/-20% of the nominal thickness, preferably +/- 10% of the nominal thickness, particularly preferred +/- 5% of the nominal thickness.

5. The functional panel (1) according to one of the preceding claims, characterised in that the functional panel (1) has a first load direction (R1) which extends parallel to the fibre direction of the cover layer on the pressure side (2) and parallel to the surface of the functional panel (1) forming the pressure side (2), and the functional panel (1) has a second load direction (R2) oriented at right angles to the first load direction (R1), and in that the bending strength and/or the bending modulus of elasticity of the functional panel (1) along the first load direction (R1) differs from the bending strength and/or the bending modulus of elasticity of the functional panel (1) along the second load direction (R2) by a maximum of 30%, preferably by a maximum of 20%, particularly preferred by a maximum of 10%.

6. The functional panel (1) according to one of the preceding claims, characterised in that a coating (5a, 5b) is applied to the cover layer formed by at least one veneer layer (A, B), wherein the coating (5a, 5b) is made of a material different from the veneer layers (A, B).

7. The functional panel (1) according to claim 6, characterised in that, on the pressure side (2), a coating (5a) is applied which is made of a thermoplastic, particularly of polypropylene, and/or in that, on the tension side (3), a coating (5b) is applied which is made of a thermosetting plastic, particularly of a phenolic material.

8. The functional panel (1) according to one of the claims 6 or 7, characterised in that the bending strength and/or the bending modulus of elasticity of the coating (5a, 5b) are substantially identical along the first load direction (R1) and along the second load direction (R2).

9. The functional panel (1) according to one of the claims 6 to 8, characterised in that the bending strength and/or the bending modulus of elasticity of the coating (5a) are smaller than the bending strength and/or the bending modulus of elasticity of a veneer layer along the fibre direction, and the bending strength and/or the bending modulus of elasticity of the coating (5a) are larger than the bending strength and/or the bending modulus of elasticity of a veneer layer transverse to the fibre direction, and/or the bending strength and/or the bending modulus of elasticity of the coating (5b) on the tension side (3) are smaller than the bending strength and/or the bending modulus of elasticity of a veneer layer along the fibre direction and the bending strength and/or the bending modulus of elasticity of the coating (5a) are larger than the bending strength and/or the bending modulus of elasticity of a veneer layer transverse to the fibre direction.

10. The functional panel (1) according to one of the claims 6 to 9, characterised in that the thicknesses of the coatings (5a, 5b) are part of the thickness the functional panel (1) and are therefore also taken into account in the definition of the position of the central plane (ME).

11. Use of a functional panel (1) according to one of the preceding claims as a formwork shell for the formwork of a building part.

12. The use according to claim 11, characterised in that the pressure side (2) of the functional panel (1) used as a formwork shell faces the material, particularly the concrete material, of the building part to be erected.

13. The use according to claim 11 or 12, characterised in that the functional panel (1) used as a formwork shell is fastened to a formwork support (6) on its tension side (3).

14. A method for producing a functional panel (1) according to one of the claims 6 to 10, comprising the steps of
A) connecting the veneer layers (A, B) in a materially bonded manner,
B) applying the coatings (5a, 5b) to the cover layers of the connected veneer layers (A, B).

15. A method for producing the formwork of a building part, wherein at least one functional panel (1) according to one of the claims 1 to 10 is used as a formwork shell, comprising the steps of
I) setting up and positioning a formwork support (6),
II) attaching at least one formwork shell formed by a functional panel (1), wherein the pressure side (2) is oriented towards the building part to be erected, and the tension side (3) is oriented towards the formwork support (6), and wherein the orientation of the formwork shell is variable about a position axis (PA) oriented towards the pressure side (2) in the normal direction (N) since the mechanical properties of the functional panel (1), particularly its bending strength and/or its bending modulus of elasticity, are identical in all load directions orthogonal to the position axis (PA) or deviate from each other by a maximum of 30%, preferably by a maximum of 20%, particularly preferred by a maximum of 10%.
